(19) United States
(12) Patent Application Publication
(10) Pub. No.: US 2003/0193562 A1
(43) Pub. Date: Oct. 16, 2003

(54) Natural vision-based video surveillance system

(76) Inventor: Brian S. Corzillus, Cloverdale, CA (US)

Correspondence Address: Laura G. Barrow, Esq., P.O. Box 215, Estero, FL, 33928-0215, US

(21) Appl. No.: 10/122,682

(22) Filed: Apr. 15, 2002

(51) Int. Cl. H04N 7/18

(52) U.S. Cl. 348/148; 348/143

(57) ABSTRACT

A video camera surveillance system is described for attachment to either a remote vehicle or carrier. The video camera system comprises a first video camera having a lens that provides for a wide field of view (WFOV) image. The video camera system also comprises a second video camera having a lens that provides for a narrow, high definition field of view (NFOV) image. The video camera system is operatively connected to a control station for monitoring the cameras and in some aspects of the invention, steering the second camera. The CPU is provided with interface software designed to receive streaming visual data corresponding to the images transmitted by the camera system. The interface software is also designed to display simultaneously on the monitor a first window containing the WFOV image transmitted by the first camera and a second window containing a narrow field of view (NFOV) image transmitted by the second camera such that the second window display is co-located near the first window.

### BACKGROUND AND SUMMARY OF THE INVENTION

There are many fields where a video system is used to connect a remote operator or observer to the events at hand. With a singular video source, the operator or observer is restrained visually by the field of view of the lens. In cases where a wide-angle lens is employed to give the operator a broader perspective, the perspective comes at a loss of definition. In the field of remotely piloted vehicles, for example, a camera is employed to provide the operator the visual information necessary to pilot the vehicle and/or gather intelligence data; however, with a restricted field of view, as has been traditionally provided in these systems, the operator's natural vision processing facilities are considerably handicapped and thus critical information may be overlooked.

It is therefore desirable to have a camera system that provides the operator or observer a more natural visual presentation in camera surveillance operations, for example, thus including both a peripheral/wide field of view vision as well as a high-definition/narrow field of view vision.

In certain aspects, the present invention is directed to a video surveillance system comprising a video camera system for attachment to a remote carrier such as a remote vehicle or a remote stationary structure (e.g. a building, camera stand, etc.). The video camera system comprises a first video camera having a lens that provides for a wide field of view (WFOV) image. The video camera system also comprises a second video camera having a lens that provides for a narrow, high definition field of view (NFOV) image. The video camera system is operatively connected (e.g. via modem) to a control or monitoring station comprising a computer system, wherein the computer system includes a CPU, a visual display monitor, and at least one input control unit (e.g. standard joystick or custom hand-controller) for remotely steering the second video camera. The CPU is provided with interface software designed to receive streaming visual data corresponding to the images transmitted by the camera system. The interface software is also designed to display simultaneously on the monitor a first window containing the WFOV image transmitted by the first camera and a second window containing a narrow field of view (NFOV) image transmitted by the second camera such that the second window display is co-located adjacent the first window. In addition, the first window may contain a rectangle surrounding a portion of the WFOV image corresponding to the NFOV image displayed in the second window. Other aspects of the present invention include software that calculates and displays on the monitor directional information corresponding to the NFOV image transmitted by the second camera. The second camera may be mounted on a steerable, gyro-stabilized gimbaled platform or a non-stabilized platform operable by the user via the input device (e.g. joystick) at the control station.

### BRIEF DESCRIPTION OF THE DRAWINGS

FIG. 1 is a schematic illustration of the remote video camera system attached to the underside of an aerial vehicle.

FIG. 2 illustrates exemplary imagery displayed in separate windows on a computer monitor of the present invention.

FIG. 3 is a schematic flow chart illustrating the operation of the present invention.

### DETAILED DESCRIPTION OF THE PREFERRED EMBODIMENT

The present invention is directed to a camera surveillance system comprising a video camera system for attachment to a remote vehicle and a control station comprising a CPU, monitor, modem, and input device operatively connected to the video camera system. The invention, as described in more detail below, provides for concurrent acquisition and display of visual information transmitted by the camera system, wherein the visual display comprises (1) a peripheral/wide field of view (WFOV) display transmitted by one video camera of the video camera system and (2) a high definition/narrow field of view (NFOV) display transmitted by a second video camera of the camera system. As discussed in more detail below, the second camera is preferably steerable by the control station operator.

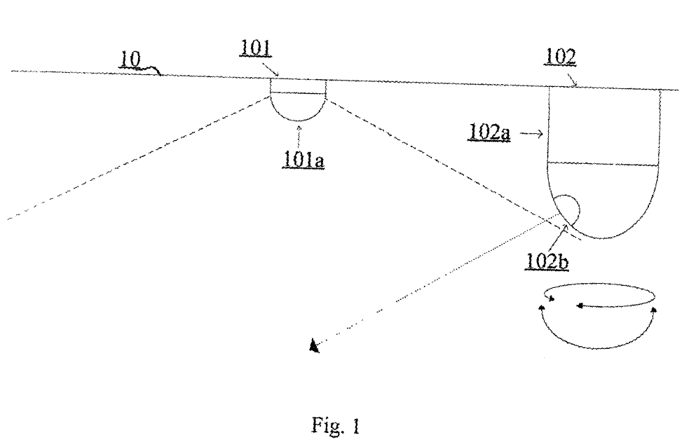

Referring now to the figures, where similar reference numbers correspond to similar features of the invention, the present invention comprises a video camera system 101, 102 attached to a remote vehicle (moving or non-moving), including, but not limited to, an airplane, automobile, truck, military vehicle, and the like. Alternatively, the video camera system may be attached to a remote, non-vehicular stationary carrier, including, but not limited to, one or more camera stands, buildings, walls, ceilings, signs, and the like. FIG. 1 illustrates schematically the underside of an airplane or a remote carrier such as a ceiling 10 having attached thereto a first video camera 101 having a WFOV lens for transmitting video images corresponding to an observer's peripheral vision. This WFOV camera 101 has wide angle lens preferably fixed at 60-180 degrees, most preferably 120 degrees. The video camera system further includes a second video camera 102 having a NFOV lens 102b for zooming in on a particular object or region of interest within the wide field of view. Preferably, the first video camera 101 is stationary while the second video camera 102 is steerable by a remote operator, as discussed further below. Provision of this steering capability allows the operator the ability to zoom in on a region of interest within the WFOV transmitted by the first camera 101. It will be further recognized by the skilled artisan that the first video camera may be provided with steering features similar or identical to the second video camera, if desired.

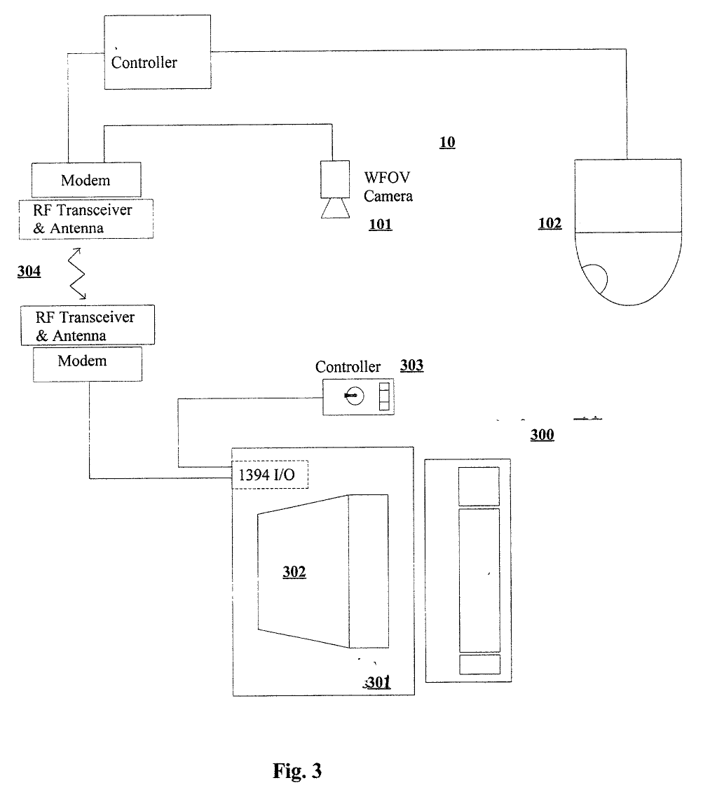

As shown schematically in FIG. 3, the remote video camera system is in communication with a control station 300 comprising a CPU 301, a visual display monitor 302, and at least one input control device 303, such as a joystick or custom hand controller, for remotely steering the second video camera 102. The control station and video camera system are operatively linked via a radio frequency-controlled modem system 304. Loaded on the CPU 301 is interface software designed to receive streaming visual data corresponding to the images recorded by the video camera system 101, 102.

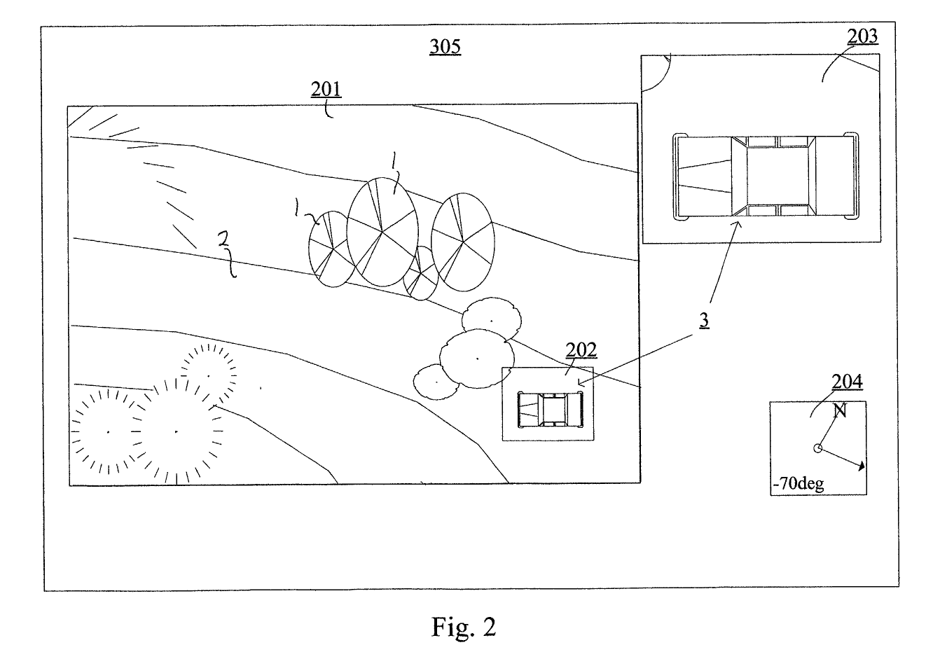

FIG. 2 illustrates the display screen 305 of the control station's monitor 302. The interface software is designed to display simultaneously on the monitor separate windows corresponding to the images transmitted by the respective cameras of the video camera system. The larger window 201 displays the WFOV image transmitted by the first video camera 101. A smaller window 203 displays the NFOV (i.e. zoomed in) image transmitted by the second video camera. As an example, FIG. 2 illustrates schematically the WFOV image of a landscape with trees or shrubbery 1, a road 2, and an automobile 3 traveling thereon. The object “zoomed” in on (i.e. NFOV) by the second camera is the automobile 3, which is displayed in the second window 203 co-located next to the larger window 201. The image of the automobile 3 is also displayed within the WFOV window 201, since the first camera transmits that image of the automobile, as well, to the control station monitor. Within the WFOV window 201, the image of the automobile 3 viewed and transmitted concurrently by the NFOV camera is indicated by a rectangle 202 as shown in FIG. 2. It will be appreciated by those of ordinary skill in the art that other means for indicating the objects simultaneously transmitted by the second camera may be employed, such as other geometric shapes (e.g. a circle, triangle, etc.) surrounding the image, an arrow in close proximity or superimposed on the image, color highlighting around or superimposed on the image, and the like.

The visual display may also include a third window 204 containing information corresponding to the elevation and azimuth angles of the NFOV camera 102 or camera gimbal 102a. This window 204 may also contain a reference to either the magnetic north or the direction of travel of the remote vehicle 10 to which the video cameras 101, 102 are secured.

In the preferred embodiment of the present invention, each of the windows 201, 203, 204 and indicator 202 are sizeable and can be moved by the operator anywhere on the screen, including overlaying each other, as desired. This ability allows the operator to configure the wide- and narrow-view perspectives to best suit his/her perceptual needs.

In operation, as the operator steers the NFOV camera 102, the representative rectangle, 202 (size based on zoom factor for the NFOV lens), for example, or other indicator means, is moved around the large window, indicating the view port for the NFOV. Preferably, the WFOV and NFOV images 201, 203 are displayed in separate windows, as shown in FIG. 2, as opposed to superimposing the two images in a single window. Provision of a second smaller and stationary window 203 displaying the NFOV imagery allows for minimal distraction to the operator, while providing real-time feedback regarding the source of the stabilized NFOV image. In this manner, the operator normally monitors the larger WFOV window, scanning large expanses of territory and looking for objects or activity that may be out of the ordinary, for example. When something catches the operator's eyes (i.e. moving into the operator's “peripheral vision” a represented by the WFOV), he/she can then move the NFOV camera 102 quickly to the desired region (without disrupting/blocking any portion of the WFOV stream), and then glance to the smaller NFOV window 203 to observe the area of interest in detail, thus matching very closely how individuals naturally observe or scan large areas of their environment within their natural field of view for visual information.

A variety of video cameras may be employed in the present invention, including, but not limited to, conventional (i.e. daylight) video cameras, infrared spectrum cameras, and other band-specific video sources. An exemplary video camera for transmitting NFOV video images is a SONY DFW-VL500 camera (internal x12 5.5->64 mm zoom lens). The camera 102 may be mounted within a Wescam Model 11 gimbal platform 102a, which is a steerable, gyro-stabilized gimbaled platform with direct control (and response) as to azimuth and elevation in radians or degrees, as well as control over the camera lens, zoom, and iris. The gimbal may be mounted in a receptacle (not shown) on the underbelly of the aircraft, for example, in order to lower its profile and potential for creating a blind spot in the WFOV camera imagery. Alternatively, the camera 102 may be mounted on a non-stabilized platform, wherein the NFOV image is electronically or software stabilized by means known by those of ordinary skill in the art

An exemplary WFOV video camera is a SONY DFW-V500 camera with a 2.3 mm Pelco lens (143 degree diagonal view, 116 degree horizontal, 87 degree vertical) which may be mounted directly to the remote vehicle, for example, through an optical portal 101. While the preferred embodiment contains as described and illustrated herein contains no external lens control (focus is thus set to infinity), one can be implemented if desired.

Both exemplary cameras have a ⅓″ imaging area (sensor) which makes an 8 mm lens the equivalent of a “normal” lens (i.e. one that closely approximates the human eye's focused perspective, but not the angle of view). Both the cameras and the Wescam M 11 gimbaled camera platform preferably use the IEEE1394 (1394) high performance serial bus communication standard for both the transport of video as well as command and control. As known by those of ordinary skill in the art, the 1394 data transport medium is capable of carrying synchronous, live, full-frame video from several cameras simultaneously, along with asynchronous control and response data. In the preferred embodiment of the present invention, video image data transmitted from both cameras 101, 102, positional data of both the gimbal platform and camera lenses, and data concerning the cameras' current settings (e.g. lens settings, shutter speed, etc. and operational status (e.g. whether cameras are powered on, capturing video, etc.) is transported via the IEEE1394 serial bus to a high speed modem that encodes the data stream onto a radio frequency (RF) link between the remote vehicle 10 and control station 300.

At the control station, the RF link is sent through a modem that extracts the 1394 data stream and passes the data to a standard x86 PC CPU equipped with a 1394 interface card and WINDOWS-based software operating system (or other suitable graphical user interface). The CPU is also responsible for receiving control signals from the operator, via a graphical user interface input and an external joystick control or custom hand controller 303, and encoding these into the 1394 data stream for transport back up to the remote vehicle and the respective video camera system and gimbal platform units. The primary control signals include gimbal azimuth, elevation, and rotation control as well as camera and lens control.

Video data conversion is straightforward, using industry standard protocols described for the cameras and the gimbal and consequently known by those of ordinary skill in the art. The WFOV video, for example, is converted to bitmap (Microsoft Windows .bmp) format frames and written into (i.e. displayed within) the first WFOV primary display window 201. The NFOV video data is converted in the same manner and written into the smaller NFOV window 203. Given the remote vehicle's or carrier's position (e.g. compass heading and directional vectors), the current NFOV view is represented by a geometric shape, such as a rectangle as shown, for example (or similar indicator means) 202 drawn into the primary window 201, as discussed above. This same positional information is also used to update the graphic display window 204 discussed above.

In applications of the present invention where transmission bandwidth may be limited, the present invention may provide means for the reduction of video frame rates (e.g. similar to that described in U.S. Pat. No. 4,405,943). Specifically, the video cameras may be configured to alternately generate frames, thus keeping the relative bandwidth to the equivalent of one camera. Frame rates may be reduced further as necessary if additional bandwidth restrictions apply. Control over these frame rate reductions can be initiated by the operator from the control station or through the remote vehicle's electronics.

While the present invention is not dependent upon image de-warping techniques, technologies such as those described in U.S. Pat. Nos. 5,990,941 and 6,005,611, for example, may be employed to further enhance the peripheral or wide-angle perspective.

The inventive camera surveillance system as described and illustrated herein provides for the concurrent acquisition and display of visual information for both a peripheral (i.e. wide-angle) and a primary focal or narrow field of view, the latter being steerable and preferably, image-stabilized. The described invention provides the operator with the ability to accurately and naturally assess an environment under surveillance in real-time, without complex processing of the video information. This invention serves as an alternative to sequential image acquisition and subsequent image mosaicing or post-image processing in rapid, wide-area surveillance.

I claim:

1. A surveillance system comprising:
a. a video camera system for attachment to a remote vehicle, said camera system including a first video camera having a lens for viewing a wide field of view image and a remotely steerable second camera having a lens for viewing a higher definition narrow field of view image within said wide field view of image;
b. a control station comprising a computer system, said computer system including a CPU, a visual display monitor, and at least one input control device, wherein said computer system is operatively connected to said camera system via a modem system and includes interface software designed to receive streaming visual data corresponding to said images;
c. said interface software further designed to display on said monitor a first window containing said wide field of view image, a second window containing said narrow field of view image, said second window co-located with said first window, and wherein said first window further contains an indicator highlighting a portion of said wide field of view image corresponding to said narrow field of view image displayed in said second window; and
d. said CPU further having interface software designed to allow a user to remotely steer said second camera via said at least one input control device and said modem system.

2. The surveillance system of claim 1, wherein said indicator is a geometric shape surrounding a portion of said wide filed of view image.

3. The surveillance system of claim 1, wherein said CPU further includes software that calculates and displays on said monitor directional information corresponding to the images transmitted by said second camera.

4. The surveillance system of claim 3, wherein said directional information is displayed in a separate third window co-located with said first and second windows on said monitor.

5. The surveillance system of claim 3, wherein said indicator is a geometric shape surrounding a portion of said wide filed of view image.

6. The surveillance system of claim 5, wherein said directional information is displayed in a separate third window co-located with said first and second windows on said monitor.

7. The surveillance system of claim 2, wherein said directional information includes azimuth and directional information.

8. The surveillance system of claim 7, wherein said directional information is displayed in a separate third window co-located with said first and second windows on said monitor.

9. The surveillance system of claim 1, wherein said second camera is mounted on a steerable platform operable by said user via said input device, said platform designed for attachment to said remote vehicle, and wherein said platform is selected from the group consisting of (a) non gyro-stabilized platforms wherein said narrow field of view image is electronically stabilized and (b) gyro-stabilized platforms.

10. The surveillance system of claim 9, wherein said CPU further includes software that calculates and displays on said monitor directional information corresponding to the images transmitted by said second camera.

11. The surveillance system of claim 10, wherein said directional information is displayed in a separate third window co-located with said first and second windows on said monitor.

12. The surveillance system of claim 9, wherein said indicator is a geometric shape surrounding a portion of said wide filed of view image.

13. The surveillance system of claim 12, wherein said CPU further includes software that calculates and displays on said monitor directional information corresponding to the images transmitted by said second camera.

14. The surveillance system of claim 13, wherein said directional information is displayed in a separate third window co-located with said first and second windows on said monitor.

15. The surveillance system of claim 1, wherein each of said first and second cameras are configured to alternately generate video frames during bandwith-restricted operations.

16. The surveillance system of claim 15, wherein said indicator is a geometric shape surrounding a portion of said wide filed of view image.

17. The surveillance system of claim 15, wherein said CPU further includes software that calculates and displays on said monitor directional information corresponding to the images transmitted by said second camera.

18. The surveillance system of claim 17, wherein said directional information is displayed in a separate third window co-located with said first and second windows on said monitor.

19. The surveillance system of claim 15, wherein said second camera is mounted on a steerable platform operable by said user via said input device, said platform designed for attachment to said remote vehicle, and wherein said platform is selected from the group consisting of (a) non gyro-stabilized platforms wherein said narrow field of view image is electronically stabilized and (b) gyro-stabilized platforms.

20. The surveillance system of claim 19, wherein said CPU further includes software that calculates and displays on said monitor directional information corresponding to the images transmitted by said second camera.

21. The surveillance system of claim 20, wherein said directional information is displayed in a separate third window co-located with said first and second windows on said monitor.

22. A surveillance system comprising:
a. a video camera system for attachment to a remote carrier, said camera system including a first video camera having a lens for viewing a wide field of view image and a remotely steerable second camera having a lens for viewing a higher definition narrow field of view image within said wide field view of image;
b. a control station comprising a computer system, said computer system including a CPU, a visual display monitor, and at least one input control device, wherein said computer system is operatively connected to said camera system via a modem system and includes interface software designed to receive streaming visual data corresponding to said images;
c. said interface software further designed to display on said monitor a first window containing said wide field of view image, a second window containing said narrow field of view image, said second window co-located with said first window, and wherein said first window further contains an indicator highlighting a portion of said wide field of view image corresponding to said narrow field of view image displayed in said second window; and
d. said CPU further having interface software designed to allow a user to remotely steer said second camera via said at least one input control device and said modem system.

23. The surveillance system of claim 22, wherein said indicator is a geometric shape surrounding a portion of said wide filed of view image.

24. The surveillance system of claim 22, wherein said CPU further includes software that calculates and displays on said monitor directional information corresponding to the images transmitted by said second camera.

25. The surveillance system of claim 24, wherein said directional information is displayed in a separate third window co-located with said first and second windows on said monitor.

26. The surveillance system of claim 24, wherein said indicator is a geometric shape surrounding a portion of said wide filed of view image.

27. The surveillance system of claim 26, wherein said directional information is displayed in a separate third window co-located with said first and second windows on said monitor.

28. The surveillance system of claim 23, wherein said directional information includes azimuth and directional information.

29. The surveillance system of claim 28, wherein said directional information is displayed in a separate third window co-located with said first and second windows on said monitor.

30. The surveillance system of claim 22, wherein said second camera is mounted on a steerable platform operable by said user via said input device, said platform designed for attachment to said remote carrier.

31. The surveillance system of claim 30, wherein said CPU further includes software that calculates and displays on said monitor directional information corresponding to the images transmitted by said second camera.

32. The surveillance system of claim 31, wherein said directional information is displayed in a separate third window co-located with said first and second windows on said monitor.

33. The surveillance system of claim 30, wherein said indicator is a geometric shape surrounding a portion of said wide filed of view image.

34. The surveillance system of claim 33, wherein said CPU further includes software that calculates and displays on said monitor directional information corresponding to the images transmitted by said second camera.

35. The surveillance system of claim 34, wherein said directional information is displayed in a separate third window co-located with said first and second windows on said monitor.

36. The surveillance system of claim 22, wherein each of said first and second cameras are configured to alternately generate video frames during bandwith-restricted operations.

37. The surveillance system of claim 36, wherein said indicator is a geometric shape surrounding a portion of said wide filed of view image.

38. The surveillance system of claim 36, wherein said CPU further includes software that calculates and displays on said monitor directional information corresponding to the images transmitted by said second camera.

39. The surveillance system of claim 38, wherein said directional information is displayed in a separate third window co-located with said first and second windows on said monitor.

40. The surveillance system of claim 36, wherein said second camera is mounted on a steerable platform operable by said user via said input device, said platform designed for attachment to said remote carrier.

41. The surveillance system of claim 40, wherein said CPU further includes software that calculates and displays on said monitor directional information corresponding to the images transmitted by said second camera.

42. The surveillance system of claim 41, wherein said directional information is displayed in a separate third window co-located with said first and second windows on said monitor.
